(19) United States
(12) Patent Application Publication
(10) Pub. No.: US 2025/0308215 A1
(43) Pub. Date: Oct. 2, 2025

(54) METHOD AND SYSTEM FOR TRAINING INSTANCE SEGMENTATION MODEL

(71) Applicants: Hyundai Motor Company, Seoul (KR); Kia Corporation, Seoul (KR)

(72) Inventors: Minhoe Hur, Singapore (SG); Dezhao Huang, Singapore (SG); Keng Teck Ma, Singapore (SG); Evan Ling, Singapore (SG)

(21) Appl. No.: 18/946,630

(22) Filed: Nov. 13, 2024

(30) Foreign Application Priority Data
Mar. 29, 2024 (KR) 10-2024-0043403

(51) Int. Cl. G06V 10/774; G06V 10/26; G06V 10/776; G06V 10/82; G06V 20/52

(52) U.S. Cl. CPC G06V 10/774; G06V 10/776; G06V 20/52; G06V 10/26; G06V 10/82

(57) ABSTRACT

An instance segmentation model training method includes training the instance segmentation model firstly based on a first data set stored in a first database, and training the firstly-trained instance segmentation model secondly based on a second dataset stored in a second database, where the second dataset includes a large-scale open-source dataset and a segmentation target object-absent image acquired by capturing a working environment within an industrial site.

### CROSS REFERENCE TO RELATED APPLICATION

The present application claims priority to Korean Patent Application No. 10-2024-0043403, filed Mar. 29, 2024, the entire contents of which is incorporated herein for all purposes by this reference.

### TECHNICAL FIELD

The present disclosure relates to training an instance segmentation model, and more particularly, to a method and system for training an instance segmentation model tailored for effectively monitoring industrial sites.

### BACKGROUND

Instance segmentation involves detecting and segmenting distinct instances within an image, distinguishing the pixels associated with each object. In autonomous industrial operations, instance segmentation is used for safety monitoring, such as detecting objects entering hazardous areas of autonomously operating industrial sites.

In this regard, deep learning and artificial intelligence (AI) models may be effective for instance segmentation.

As with most deep learning models, instance segmentation models are typically trained using large-scale open-source datasets.

However, using instance segmentation models trained on open-source datasets directly in industrial environments can lead to performance degradation. For example, open-source training-based instance segmentation models may misclassify human-like objects as humans in industrial settings.

### SUMMARY

The present disclosure is directed to a method and system for training an instance segmentation model tailored for effectively monitoring industrial sites.

The present disclosure is also directed to a method and system for training an instance segmentation model multiple times based on different datasets.

The present disclosure is also directed to a method and system for training an instance segmentation model using a dataset including segmentation target object-absent images taken within the working environment of an industrial site.

The present disclosure is also directed to a method and system for training an instance segmentation model using an updated dataset when the performance test results of the trained instance segmentation model do not meet the criteria.

According to one aspect of the present disclosure, a method for training an instance segmentation model can include training the instance segmentation model firstly based on a first data set stored in a first database, and training the firstly-trained instance segmentation model secondly based on a second dataset stored in a second database.

In some implementations, the second dataset can include a large-scale open-source dataset and a segmentation target object-absent image acquired by capturing a working environment within an industrial site.

In some implementations, the method can further include capturing the working environment within the industrial site to acquire the segmentation target object-absent image, and storing the segmentation target object-absent image in the second database.

In some implementations, storing the segmentation target object-absent image in the second database can include transforming the segmentation target object-absent image and storing the transformed segmentation target object-absent image in the second database.

In some implementations, transforming the segmentation target object-absent image can include horizontally flipping or resizing the segmentation target object-absent image.

In some implementations, storing the segmentation target object-absent image in the second database can include augmenting the segmentation target object-absent image by inserting a target object and storing the augmented image in the second database.

In some implementations, the method can further include testing the performance of the secondly-trained instance segmentation model.

In some implementations, the method can further include repeating, based on the performance test result failing a predetermined criterion, the training of the firstly-trained instance segmentation model.

In some implementations, the method can further include updating, before repeating the training of the firstly trained instance segmentation model, the second dataset by storing the segmentation target object-absent image acquired by capturing a working environment within an industrial site in the second database.

According to another aspect of the present disclosure, a system for training an instance segmentation model can include a first training module configured to firstly train the instance segmentation model based on a first data set stored in a first database, and a second training module configured to train the firstly-trained instance segmentation model secondly based on a second dataset stored in a second database.

In some implementations, the system can further include an image acquisition module configured to capture the working environment within the industrial site to acquire the segmentation target object-absent image and store the segmentation target object-absent image in the second database.

In some implementations, the image acquisition module can transform the segmentation target object-absent image and store the transformed segmentation target object-absent image in the second database.

In some implementations, the image acquisition module can horizontally flip or resize the segmentation target object-absent image.

In some implementations, the image acquisition module can augment the segmentation target object-absent image by inserting a target object and store the augmented image in the second database.

In some implementations, the system can further include a testing module configured to test the performance of the secondly-trained instance segmentation model.

In some implementations, the testing module can repeat, based on the performance test result failing a predetermined criterion, the training of the firstly-trained instance segmentation model.

In some implementations, the testing module can output a control signal, based on the performance test result failing a predetermined criterion, to update the second dataset by instructing the image acquisition module to acquire a segmentation target object-absent image and store the image in the second database.

According to implementations of the present disclosure, an instance segmentation model can be trained using large-scale open-source datasets and a dataset including segmentation target object-absent working environment images captured within the working environment of an industrial site.

Additionally, when the performance test results of the trained instance segmentation model do not meet the criteria, the instance segmentation model can be further trained using a dataset including additional segmentation target object-absent images.

Therefore, it can be beneficial for monitoring working environments within an industrial site and can provide a high-performance instance segmentation model.

According to implementations of the present disclosure, the segmentation target object-absent working environment images used for training are devoid of segmentation target objects. Therefore, labeling for the segmentation target object is not required, potentially saving time and costs associated with training the instance segmentation model.

### BRIEF DESCRIPTION OF THE DRAWINGS

FIG. 1 is a diagram illustrating an example of an instance segmentation model training system 100.

FIG. 2 is a flowchart illustrating an example of an instance segmentation model training method.

FIG. 3 is a graph illustrating an example of the confidence threshold related to the test false positives per image (FPPI) results for dataset 1 in Table 1.

FIG. 4 is a graph illustrating an example of the confidence threshold related to the test FPPI results for Dataset 2 in Table 1.

### DETAILED DESCRIPTION

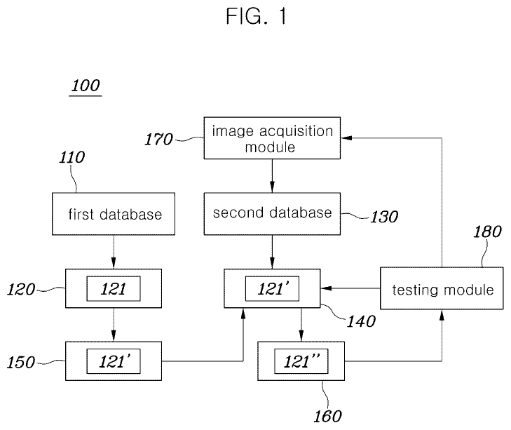

FIG. 1 is a diagram illustrating an example of an instance segmentation model training system 100.

With reference to FIG. 1, the instance segmentation model training system 100 can include a first database 110, a first training module 120, a second database 130, and a second training module 140.

The instance segmentation model training system 100 can further include a first memory 150, a second memory 160, an image acquisition module 170, and a testing module 180.

For example, the first memory 150 and the second memory 160 can include a volatile memory and/or a non-volatile memory. The volatile memory may include a dynamic random-access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), a data boosting (DBM) memory), and the like. The non-volatile memory may include a magnetic random-access memory (MRAM), a read only memory (ROM), programmable ROM (PROM), an electrically programmable ROM (EPROM), an electrically erasable programmable ROM (EEPROM), flash memory, and the like.

For example, the first training module 120, the second training module 140, and the testing module 180 may correspond to a data processing device implemented as hardware having a circuit of a physical structure to execute desired operations. For example, the desired operations may include codes or instructions included in a program. For example, the data processing device implemented as hardware may include a microprocessor, a central processing unit, a processor core, a multi-core processor, a multiprocessor, an application-specific integrated circuit (ASIC), and a field programmable gate array (FPGA).

The instance segmentation model may refer to a neural network model that can be trained according to the training method proposed in the present disclosure. The trained instance segmentation model can be configured to detect humans and can be applied to monitoring systems in industrial sites.

For example, the neural network model can be implemented using region convolutional neural network (R-CNN), faster R-CNN, and mask R-CNN.

The first database 110 can store a dataset used for firstly training the instance segmentation model. For example, a dataset may refer to a first dataset or source dataset.

In some implementations, the first dataset can include large-scale open-source datasets.

The first training module 120 can include an instance segmentation model 121 and receive input from the first dataset.

The instance segmentation model 121 of the first training module 120 can learn from the input provided by first dataset.

In some implementations, the instance segmentation model 121 can be trained on the first dataset and can detect predetermined object classes (e.g., humans).

The first training module 120 can store the instance segmentation model 121′ trained firstly based on the first dataset in the first memory 150.

The second database 130 can store a dataset used for secondly training the instance segmentation model. For example, a dataset stored in the second database 130 may refer to a second dataset or advanced dataset.

In some implementations, the second dataset can include large-scale open-source datasets. The second dataset can include images obtained by removing target objects from large-scale open-source datasets.

In some implementations, the second dataset can include images where the segmentation target objects (e.g., humans) are absent. For example, the images where the segmentation target objects are absent may refer to “negative images”.

For example, the segmentation target object-absent images can be captured by surveillance cameras during non-operational periods.

In some implementations, the second dataset can include segmentation target object-absent working environment images.

Thus, since segmentation target object-absent images do not include the segmentation target objects, labeling of segmentation target objects is not required, leading to savings in both cost and time.

Since segmentation target object-absent images are acquired within specific working environments, the number of obtainable segmentation target object-absent images may be limited, inevitably much fewer compared to large-scale open-source datasets.

The present disclosure includes measures to address these constraints, allowing the second dataset to include a greater number of images.

For example, the second dataset can include transformed images of segmentation target object-absent images.

By way of further example, the second dataset can include at least one of (i) horizontally flipped images of segmentation target object-absent images, (ii) resized images of segmentation target object-absent images, or (iii) resized images of the horizontally-flipped segmentation target object-absent images.

The second dataset can include images by removing the segmentation target objects from the images included in the first dataset.

The second dataset can include augmented images obtained by inserting target objects into segmentation target object-absent images.

The instance segmentation model can be trained for occlusion-robust instance segmentation without the need for labeling segmentation target objects, using augmented images obtained by inserting target objects into segmentation target object-absent images.

In some implementations, the second dataset can include a predetermined proportion of segmentation target object-absent images to improve the performance of the instance segmentation model.

For example, the proportion can be appropriately determined through performance testing of the instance segmentation model.

The second training module 140 can include the first trained instance segmentation model 121′ and receive the second dataset.

In some implementations, the second training module 140 can read the first trained instance segmentation model 121′ stored in the first memory 150.

The first trained instance segmentation model 121′ of the second training module 140 can learn the input second dataset.

The second training module 140 can store the second (or advanced) trained instance segmentation model 121″ based on the second dataset in the second memory 160.

The image acquisition module 170 can be installed within a predetermined working environment (or target working environment) and capture images of the working environment for storage in the second database 130.

In some implementations, the image acquisition module 170 can transform the acquired images as defined by a preset and store the transformed images in the second database 130.

In some implementations, the image acquisition module 170 can generate augmented images with objects based on the acquired images as defined by a preset and store the augmented images in the second database 130.

The testing module 180 can test the performance of the second trained instance segmentation model 121″ stored in the second memory 160.

For example, the testing module 180 can be installed within the working environment and read the second trained instance segmentation model 121″ stored in the second memory 160.

The testing module 180 can perform the second trained instance segmentation model 121″ to test performance based on the output of the second trained instance segmentation model 121″.

For example, performance testing of the second trained instance segmentation model 121″ can be conducted using performance testing methods applicable to neural network models.

The testing module 180 can compare the performance test results with preset criteria, and, when the performance test results do not meet the criteria, output a control signal to the second training module 140 to train the instance segmentation model 121′ loaded in the second training module 140.

The testing module 180 can deploy the instance segmentation model of the test target to the associated monitoring system when the performance test results meet the criteria.

When the performance test results do not meet the criteria, the testing module 180 can output a control signal to the image acquisition module 170 to acquire and store segmentation target object-absent images in the second database 130.

Accordingly, the second dataset stored in the second database 130 can be updated based on the additional segmentation target object-absent images being stored.

The testing module 180 can output the performance test results. For example, the testing module 180 can output the performance test results by outputting the performance test results through output methods implemented independently of the testing module 180. In some implementations, the testing module 180 can provide the performance test results to a device (e.g., user terminal) implemented independently of the instance segmentation model training system 100.

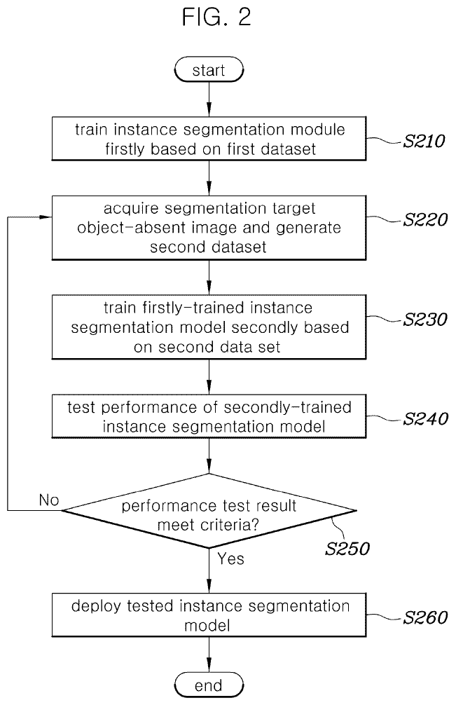

FIG. 2 is a flowchart illustrating an example of an instance segmentation model training method.

The operations depicted in FIG. 2 can be implemented on the instance segmentation model training system 100 of FIG. 1.

With reference to FIG. 1 and FIG. 2, the first training module 120 can train the instance segmentation model 121 using the first dataset stored in the first database 110 as input at step S210.

At step S210, the instance segmentation model 121 can be trained on the first dataset to detect predetermined object classes (e.g., humans).

The first training module 120 can store the first trained instance segmentation model 121′ in the first memory 150.

Subsequently, the second training module 140 can read the first trained instance segmentation model 121′ stored in the first memory 150 and train the first trained instance segmentation model 121′ using the second dataset stored in the second database 130 as input.

The second training module 140 can store the second trained instance segmentation model 121″ in the second memory 160.

In some implementations, the second dataset can be pre-stored in the second database 130 before the training begins.

For example, the second dataset can include large-scale open-source datasets and images devoid of segmentation target objects.

In some implementations, the second dataset can be stored in the second database 130 before the second training starts after the completion of the first training.

For example, before training the first trained instance segmentation model 121′, the image acquisition module 170 can capture the predetermined working environment and store the acquired segmentation target object-absent images in the second database 130 at step S220.

Accordingly, the segmentation target object-absent images stored in the second database 130 and the second dataset including a mixture with the segmentation target object-absent images can be generated.

At step S220, the image acquisition module 170 can transform the acquired images as defined by a preset and store transformed images in the second database 130.

In some implementations, the second dataset can include images transformed segmentation target object-absent images.

At step S220, the image acquisition module 170 can generate augmented images with objects based on the acquired images as defined by a preset and store the augmented images in the second database 130.

Accordingly, the second dataset can include images augmented with objects inserted into segmentation target object-absent images.

At step 230, the firstly-trained instance segmentation model can be trained based on the second dataset.

After step S230, the testing module 180 can test the performance of the second trained instance segmentation model 121″ at step S240.

Afterwards, the testing module 180 can compare the performance test results with preset criteria and determine whether the performance test results meet the criteria at step S250.

When the performance test results meet the criteria (Yes at step S250), the testing module 180 can deploy the tested instance segmentation model of the to the associated monitoring system at step S260.

In some implementations, the testing module 180 can output the performance test results.

When the performance test results do not meet the criteria (No at step S250), the testing module 180 can output a control signal to the second training module 140 and the image acquisition module 170, triggering another round of training for the instance segmentation model through steps S220 and S230.

The image acquisition module 170 can respond to control signals from the testing module 180 by capturing the working environment within the industrial site and storing the acquired segmentation target object-absent images in the second database 130. Accordingly, the second dataset stored in the second database 130 can be updated based on the additional segmentation target object-absent images being stored.

The second training module 140 can train the instance segmentation model based on the updated second dataset to improve the performance of the instance segmentation model.

Table 1 shows the false positive per image (FPPI) results tested for the instance segmentation model trained and the instance segmentation model trained according to conventional techniques.

TABLE 1
Test FPPI results

| Model | Dataset 1 | Dataset 2 |
|---|---|---|
| Comparative Example 1 | 2.01 | 1.68 |
| Comparative Example 2 | 1.46 | 1.52 |
| Implementation | 0.89 | 0.24 |

In Table 1, Comparative Example 1 represents the FFPI of a model trained based on a large-scale open-source dataset, Comparison Example 2 represents the FPPI when the weights of the model used in Comparison Example 1 are altered, and Implementation represents the FPPI of a model additionally trained based on segmentation target object-absent images acquired from the target working environment.

FPPI denotes the count of false positive samples detected per image, where FP (false positive) signifies erroneously predicted bounding boxes that suggest the presence of an object where none exists. Therefore, a lower value of FPPI indicates better performance of the model.

With reference to Table 1, it can be observed that the FPPI values for both dataset 1 and dataset 2 are low in the implementations.

Therefore, it is evident that a model trained based on a dataset including segmentation target object-absent images acquired from the target working environment, as in the implementations of the present disclosure, exhibits superior performance compared to existing models, highlighting the effectiveness of the training method in implementing instance segmentation models.

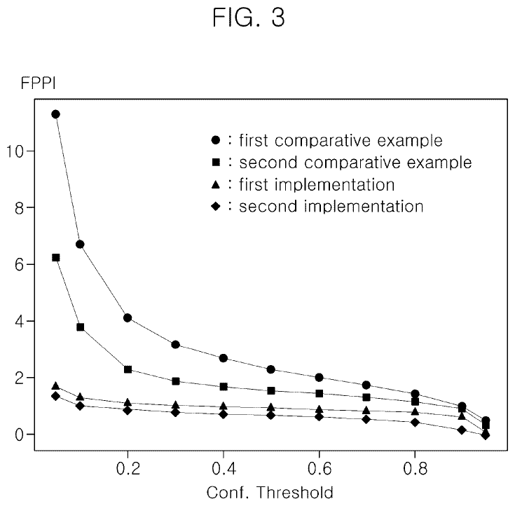

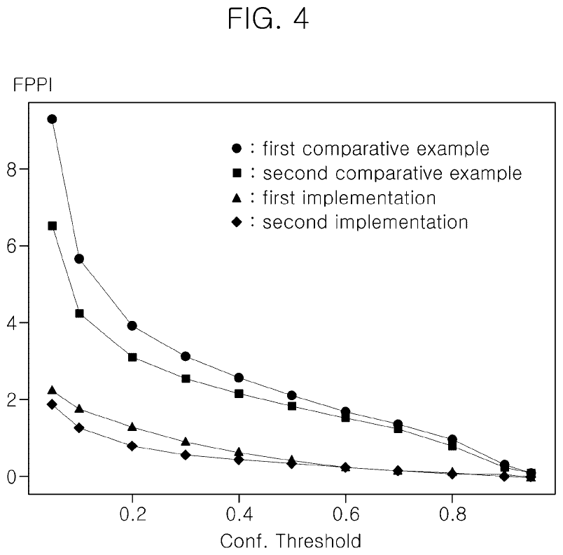

FIG. 3 is a graph illustrating an example of the confidence threshold related to the test false positives per image (FPPI) results for dataset 1 in Table 1, and FIG. 4 is a graph illustrating the confidence threshold related to the test FPPI results for Dataset 2 in Table 1.

In FIG. 3 and FIG. 4, Comparative Examples 1 and 2 represent cases where instance segmentation models were trained using datasets that did not include segmentation target object-absent images, while Implementations 1 and 2 represent cases where instance segmentation models were trained using datasets that included segmentation target object-absent images.

With reference to FIG. 3 and FIG. 4, it is evident that the FPPI for the instance segmentation models trained using datasets that included segmentation target object-absent images (Implementations 1 and 2) is lower than the FPPI for the instance segmentation models trained using datasets that did not include segmentation target object-absent images (Comparative Examples 1 and 2).

What is claimed is:

1. A method for training an instance segmentation model, the method comprising:
performing first training on the instance segmentation model based on a first data set stored in a first database; and
performing second training on the instance segmentation model on which the first trains was performed based on a second dataset stored in a second database,
wherein the second dataset comprises (i) a large-scale open-source dataset and (ii) an image without a segmentation target object that is acquired by capturing a working environment within an industrial site.

2. The method of claim 1, further comprising:
storing the image without the segmentation target object in the second database.

3. The method of claim 2, wherein storing the image without the segmentation target object in the second database comprises:
transforming the image without the segmentation target object; and
storing the transformed image without the segmentation target object in the second database.

4. The method of claim 3, wherein transforming the image without the segmentation target object comprises horizontally flipping or resizing the image without the segmentation target object.

5. The method of claim 2, wherein storing the image without the segmentation target object in the second database comprises:
augmenting the image without the segmentation target object by inserting a target object; and
storing the augmented image in the second database.

6. The method of claim 1, further comprising testing performance of the instance segmentation model on which the second training was performed.

7. The method of claim 6, further comprising repeating, based on a result of testing of the performance not satisfying a predetermined criterion, the second training on the instance segmentation model.

8. The method of claim 7, further comprising updating, before repeating the second training on the instance segmentation model, the second dataset by additionally storing the image without the segmentation target object in the second database.

9. A system configured to train an instance segmentation model, the system comprising:
a first training module configured to perform first training on the instance segmentation model based on a first data set stored in a first database; and
a second training module configured to perform second training on the instance segmentation model on which the first training was performed based on a second dataset stored in a second database,
wherein the second dataset comprises (i) a large-scale open-source dataset and (ii) an image without a segmentation target object that is acquired by capturing a working environment within an industrial site.

10. The system of claim 9, further comprising an image acquisition module configured to capture the working environment within the industrial site to acquire the image without the segmentation target object and store the image without the segmentation target object in the second database.

11. The system of claim 10, wherein the image acquisition module is configured to transform the image without the segmentation target object and store the transformed image in the second database.

12. The system of claim 11, wherein transforming the image comprises horizontally flipping or resizing the image.

13. The system of claim 10, wherein the image acquisition module is configured to augment the image without the segmentation target object by inserting a target object and store the augmented image in the second database.

14. The system of claim 9, further comprising a testing module configured to test performance of the instance segmentation model on which the second training was performed.

15. The system of claim 14, wherein the testing module is configured to, based on a result of testing of the performance not satisfying a predetermined criterion, output a control signal to the second training module to cause the second training module to repeat the second training on the instance segmentation model.

16. The system of claim 14, further comprising an image acquisition module configured to store the image without the segmentation target object in the second database,
wherein the testing module is configured to output a control signal based on a result of testing of the performance not satisfying a predetermined criterion, to update the second dataset by instructing the image acquisition module to additionally acquire the image without the segmentation target object and store the image in the second database.
